(19) United States
(12) Patent Application Publication
(10) Pub. No.: US 2004/0193400 A1
(43) Pub. Date: Sep. 30, 2004

(54) Method and system for producing cohesive phrases from fixed phrases in a natural language system

(76) Inventor: David D. McDonald, Arlington, MA (US)

Correspondence Address: Patent Department, Mitsubishi Electric Research Laboratories, Inc., 201 Broadway, Cambridge, MA, 02139, US

(21) Appl. No.: 10/395,929

(22) Filed: Mar. 24, 2003

(51) Int. Cl. G06F 17/27

(52) U.S. Cl. 704/9

(57) ABSTRACT

A method filters natural language output including fixed phrases by determining sequentially, for each fixed phrase, whether the fixed phrase has occurred in a discourse history. The fixed phrase is passed to a target component if the fixed phrase does not occur in the discourse history. If the fixed phrase does occur in the discourse history, a subsumption lattice is searched for an expressive type associated with the fixed phrase that is licensed in a context of the discourse history. The fixed phrase is converted to a filtered phrase according a realization method of the licensed expressive type and the filtered phrase is passed to the target component.

### FIELD OF THE INVENTION

This invention relates generally to systems that produce output in a natural language, and more particularly to systems that produce cohesive natural language.

### BACKGROUND OF THE INVENTION

There are many kinds of computer systems that produce output in a natural language such as English. Hereinafter, output includes both textual data, e.g., character string, and audio data, e.g., speech. Example systems include database reporting systems, voice portals, computer-aided-instruction or tutoring systems, and car navigation systems. Generally, the output can either be manually constructed as, for example, “canned text,” or the output is produced automatically from fixed phrases according to rules.

The manual method can be used when all of the output that will ever be needed is known in advance. Otherwise, the output is produced automatically as needed. The present invention is concerned with the second case where programmed rules rather than a person are the source of the natural language output.

The intent is that the output is eventually seen or heard. Consequently, the output is most effective if it conforms to expected patterns of ‘cohesion’, see Halliday et al., “Cohesion in English,” Longman, 1976. These patterns include using long detailed descriptions when an object is first mentioned, shorter descriptions when the object is mentioned again, provided that omitted portions are obvious from the context, and using pronouns if the object is mentioned repeatedly within a short period of time. Natural language, written and spoken, conform to these cohesive patterns. If the output does not conform to these patterns, it is perceived as awkward at best, and incomprehensible at worst.

The following example is taken from output of an engine tutoring system. “The next step of stopping gas-turbine engine one is to close the fuel values on gas-turbine engine one.” This is clearly a cohesion violation. A more appropriate cohesive form would be: “The next step of stopping gas-turbine stopping engine one is to close the fuel values on the engine,” or perhaps, “ . . . its fuel valves.” The problem with many prior art natural language systems is that a particular phrase is always produced in the same manner.

Systems that automatically produce natural language texts usually include two components. A first component what information needs to be output, and a second component determines how the output is presented. In the prior art, a number of system that produce cohesive output with these components are know, e.g., see Reiter et al., “Building Natural Language Generation Systems,” Cambridge University Press, 2000.

It is desired to provide a system and method for natural language systems that do not produce cohesive output.

### SUMMARY OF THE INVENTION

The invention filters natural language output generated from fixed phrases. The filtering detects instances of fixed phrases that are not cohesive in context, and replaces them with alternative forms of the fixed phrases that are cohesive in context. Then, the filtered output is passed to its intended target device.

The invention employs an application-specific database of the fixed phrases that the output can include. With each record of a fixed phrase, the invention stores the alternative forms of the fixed phrase, and a model of the contexts where the alternative forms are appropriate.

The invention intercepts the generated output, and scans it incrementally for instances of fixed phrases. Each time a particular fixed phrase is encountered, the invention uses the model to replace the fixed phrase with an alternative form that is cohesive in context, where appropriate.

Therefore, the invention maintains a discourse history of the instances of the fixed phrases that have been processed with an indication whether an alternative form was used. The history is used to determine the context.

### BRIEF DESCRIPTION OF THE DRAWINGS

FIG. 1 is a block diagram of a system incorporating a cohesion filter according to the invention;

FIG. 2 is a block diagram of the cohesion filter according to the invention;

FIG. 3A is a block diagram of a permanent fixed phrase record maintained the system of FIG. 1;

FIG. 3B is a block diagram of a temporary pre-session record maintained the system of FIG. 1;

FIG. 4 is a block diagram of a subsumption lattice according to the invention; and

FIG. 5 is a flow diagram of a method used by the system of FIG. 1 for filtering natural language output generated from fixed phrases.

### DETAILED DESCRIPTION OF THE PREFERRED EMBODIMENT

System Structure

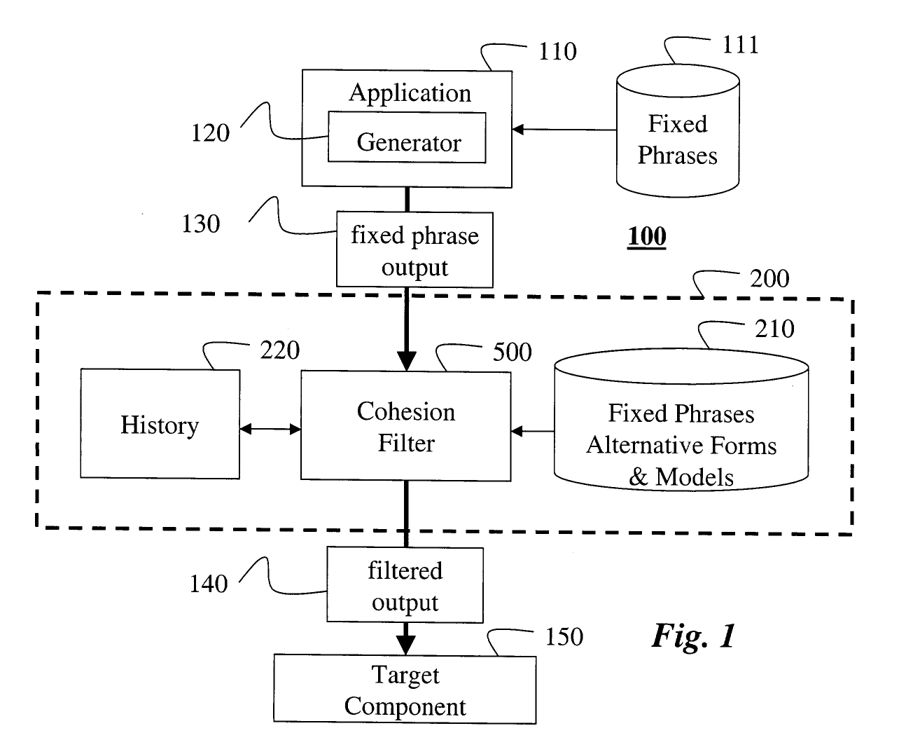

FIG. 1 a system 100 that incorporate a cohesion filtering system 200 according to the invention. The system 100 includes an application program 110 that generates 120 natural language output 130 from fixed phrases 111. The output can be in the form of text, audio signals, or other forms of computer processable natural language. The output 130 is eventually intended for a target component 150, e.g., printer, display unit, speech synthesizer, transmitter, and the like, so that it can be seen or heard.

From beginning to end, the output 130 can be regarded as a continuous sequence of fixed phrases generated 120 during a “session.” The application can concurrently maintain multiple sessions with different users, each session associated with a particular sequence of fixed phrases.

It should be understood, that additional processing can be performed on the output before it reaches the target component, and the output can be stored in memory or on a disk. Therefore, the application 110 and target component 150 are decoupled. Decoupled means that other systems and components can be interposed between the application and the target component 150.

The cohesion filtering system 200 of the invention is such an interposing system. The cohesion filtering system 200 includes a cohesion filter method 500 that accesses a permanent database 210 of fixed phrase records, and a temporary database 220 of per-session records.

System Operation

In a Java-based system, the output 130 is conveyed between components as part of ‘events’ that components issue to other components that have ‘registered’ with the issuing component as ‘listeners’. A component that is intended to receive the output registers with the component that emits the output and listens to events that incorporate the output as part of their content.

The cohesion filtering system 200 intercepts the output text 130 by registered itself as a listener with the generator 120. The target component 150 is registered as a listener to output events issued by the cohesion filtering system 200. If the output 130 is not to filtered, then the target component 150 registers directly with the generator 120.

The effect of the invention is convert the output 130 that does not exhibit the expected cohesion to filtered output 140 that does. Therefore, the cohesion filtering system 200 accesses a database 210 of records that stores the fixed phrases, alternative forms, and associated models. The system 200 also maintains the temporary discourse history 220 of a session to provide a context for the conversion.

Using the models and history, the cohesion filtering system 200 anal sizes the output 130 to detect many kinds of cohesive linguistic phenomena, as described by Halliday et al., above, subject to the constraint that the output is composed of a sequence of fixed phrases.

The simplest linguistic phenomena that the cohesion filter detects are an ‘initial reference’ and a subsequent reference’ to an object. The initial reference is the first time that a particular fixed phrase is encountered. Therefore, the fixed phrase includes a sufficient description to distinguish the object being referred from any other objects of the same class. A subsequent reference is a reference to an object that has already been referenced during the session. For cohesion, alternative forms of the fixed phrase are preferred for subsequent references.

Initial and subsequent references are an aspect of the task of ‘reference generation’, which is known in the prior art, see Reiter et al., “Building Natural Language Generation Systems,” Cambridge University Press, 2000, Bateman et al., “Selective information presentation in an integrated publication system: an application of genre-driven text generation,” Information Processing and Management: Special Issue on Summarizing Text, 31(5), pp. 753-768, September, 1995, and Dale, “Generating Referring Expressions,” MIT Press, 1992. In all instances where this art is practiced the well-known techniques for reference generation are applied within an application.

In contrast, the invention pertains to the generator 120, which does not employ state of the art reference generation techniques and instead produces the same fixed phrase every time each particular object is referenced.

Cohesion Filtering System

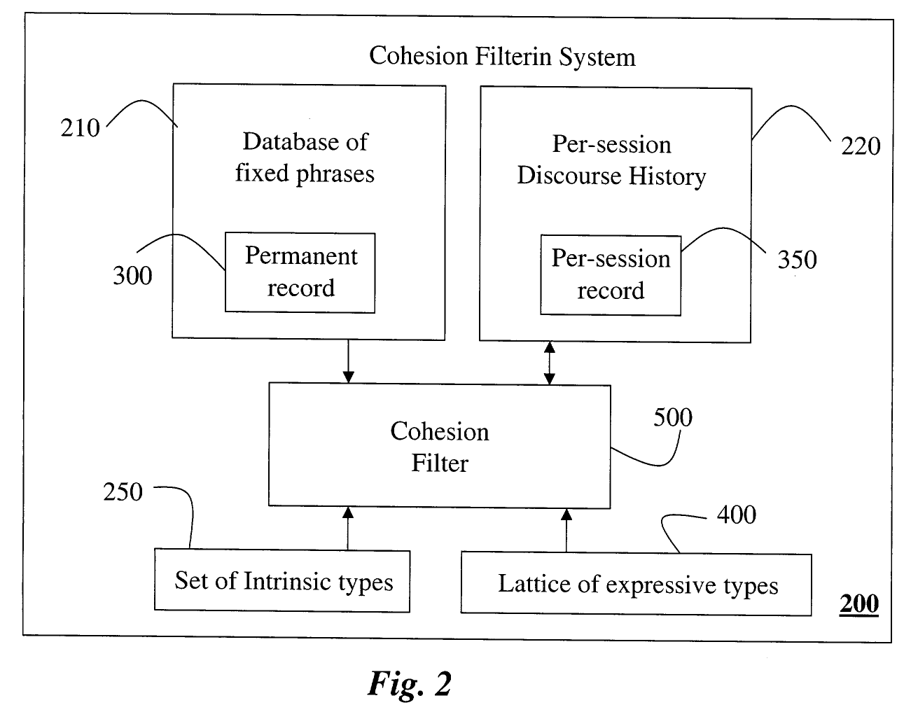

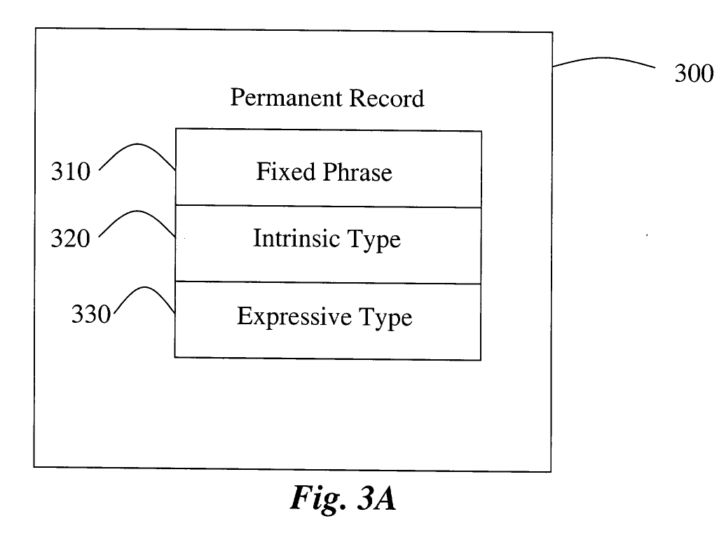

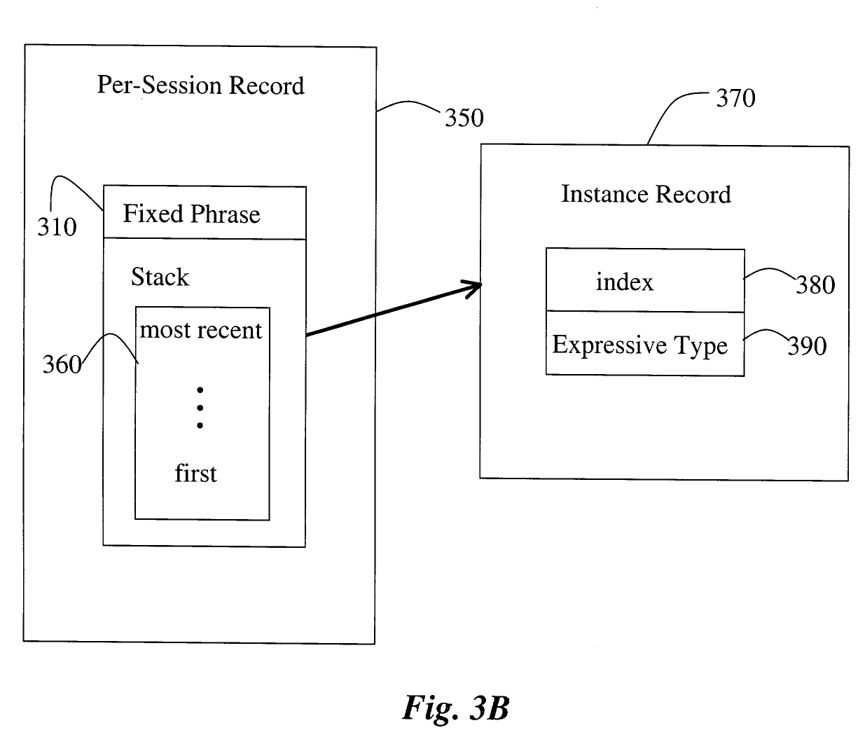

FIG. 2 shows details of the cohesion filtering system 200. The database 210 stores all fixed phrases that have been registered with the system 200. Each registered fixed phrase in the database 210 is given a permanent fixed phrase record 300, see FIG. 3A, which lists the permanent information that the cohesion filtering system 200 uses while operating on that phrase. The information in this permanent record 300 is provided at the time that the phrase is registered. The cohesion filtering system 200 also maintains a discourse history 220 of temporary per-session records 350, see FIG. 3B. that is temporary and records information that is specific to a particular session between the application 110 and a user. If the application 110 maintains more than one concurrent session, each session has its own instance of the per-session discourse history 220.

The per-session records 350 within the discourse history 220 are specific to the fixed phrases that have appeared in the output 130 and give information about decisions that the cohesion filtering system 200 has made about them. The per-session records 350 for each fixed phrase are updated each time the phrase appears in the fixed phrase output 130. The contents of the permanent records 300 and per-session records 350 are dictated by the techniques that the cohesion filter method 500 uses.

The per-session discourse history 220 as a whole includes the per-session records 350 for all of the fixed phrases that have appeared in the output 130, so far, and history is extended incrementally by additional per-session records 350 as additional fixed phrases appear incrementally in the output 130, and by extensions to existing per-session records 350 of fixed phrases that have already appeared appear again as the output 130 continues.

Permanent Fixed Phrase Records

FIG. 3A shows the contents of the permanent records 300 that are stored for each fixed phrase. To make a decision about how an object should be expressed in natural language, which is referred to herein as how an object should be ‘realized’, one needs to know two things about the object: its ‘intrinsic’ type and its ‘expressive’ type.

Therefore, the cohesion filter 500 maintains a set of intrinsic types 250 and a set of expressive types that are organized into a subsumption lattice 400. The permanent record 300 is stored for each fixed phrase as it is registered. The record 300 includes a fixed phrase 310, an intrinsic type 320 of the phrase, and an expressive type 330 of the phrase.

An intrinsic type reflects an identity of an object as an instance of a class or a natural kind. These types are typically realized as nouns, e.g., “button,” or “panel.” Their role in reference generation is to track ‘distracters,’ e.g. other recently mentioned objects of the same type, e.g. buttons, that could potentially be confused with the button about to be referenced.

An expressive type governs how an object is to be realized. Meteer, in “Expressibility and the Problem of Efficient Text Planning,” Pinter, 1992, describes how different possible realizations of an object fall into systematic classes, also known as expressive types, that are generic to a language. This facilitates reasoning about what realization choices to make. In Meteer's model, expressive types are used to reason abstractly about the options for composition. For example, expressive types facilitate the handling of lexical gaps where a given object can be alternatively referenced with or without other modifiers.

As used by the cohesion filter 500 according to the invention, expressive types incorporate information about options for subsequent reference. The filtered output 140 is more cohesive than the original output 130. This is because the cohesion filter 600 applies the most reduced realization for a fixed phrase 310, among the alternative forms defined by its expressive type 330, that is consistent with the context. The context is determiined by examining the per-session record 350 of the fixed phrase 310 in the per-session discourse history 220, and the per-session records of other fixed phrases that have also been referenced during the session.

Temporary Per-Session Records

FIG. 3B shows the structure of the per-session record 350 temporarily stored for each fixed phrase. For each fixed phrase, there is a searchable stack 360 including a set of instance records 370 organized from the most recent instance of the phrase 310 in the original text 130 to the first instance. Each instance record 370 in this stack 360 includes an index 380 characterizing where in the output 130 the fixed phrase 310 appeared. An instance record also records which expressive type 390 governed the realization of the fixed phrase at that index 380.

Subsumption Lattice

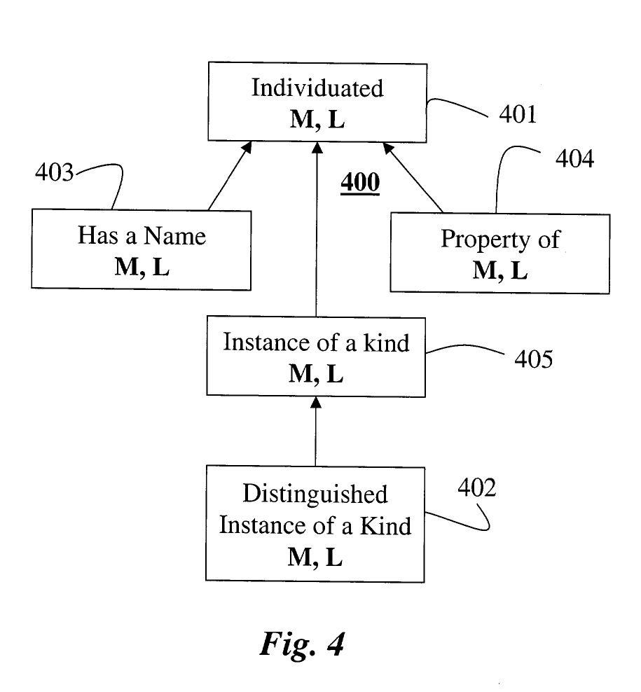

FIG. 4 shows how various expressive types according to the invention are organized top-to-bottom, in the subsumption lattice 400, from general to specific. Associated with each type is a corresponding method (M) for realization and a method (L) for determining whether the realization associated with that expressive type is licensed given the status in the per-session discourse history 220 of the fixed phrase 310 of that expressive type.

When a fixed phrase is registered, it is assigned to a bottom, leaf, expressive types in the lattice. The realization performed that leaf expressive type has the linguistic properties evidenced in the fixed phrase.

As an example, the fixed phrase “the Operation button” could be registered as having the expressive type ‘distinguished instance of a kind’ 402, because the term ‘Operation’ distinguishes this button from other instances of ‘button.’ It can be registered with the intrinsic type ‘button’ to indicate any realization of it chosen by the cohesion filter must distinguish this particular button from any other buttons in the discourse history 220 that might be distracters.

The fixed phrase “Operation” can be registered to an intrinsic type of the same name and to the expressive type ‘has a name’ 403 or ‘property of’ 404 depending on how the phrase is employed by the application 110.

To register a fixed phrase, e.g., “the Operation button,” so that the cohesion filter can operate on it, it is sufficient to execute the following three statements:

defineKind(“button”);

defineKind(“Operation”);

create(“the Operation button”,

kindNamed(“button”),

new EType.DistinguishedIOAK(

kindNamed(“button”),

kindNamed(“Operation”)));

The defineKind method creates a new intrinsic type with the indicated name (“button”). All intrinsic types are assigned the expressive type ‘has a name’ 403. The create statement registers a fixed phrase and stores its permanent record 300. The first argument is the fixed phrase 310. The second argument is the assigned intrinsic type 320, and the third is the assigned expressive type 330. Here, the expressive type ‘distinguished instance of a kind’ has been abbreviated.

The expressive type is given parameters specific to that type. The parameters refine the expressive type for an application to the fixed phrase. In this example, the parameters indicate that the ‘kind’ is the intrinsic type named “button” and that the fixed phrase is ‘distinguished’ from other instances of buttons by the intrinsic type named “Operation”.

By organizing the expressive types into a subsumption lattice according to the invention, it is the case that the cohesion filter is able to realize a fixed phrase of a given leaf expressive type with any of the realizations associated with the expressive types that dominate the leaf expressive type in the subsumption lattice. For the fixed phrase “the Operations button,” its leaf expressive type 402 is immediately dominated by the expressive type named “instance of a kind” 405, which is in turn dominated by the root expressive type in the illustrating subsumption lattice 400 named “individuated’ 401.

The cohesion filter 500 selects the highest expressive type whose licensing method L is satisfied in the discourse history 220. For the fixed phrase 310 “the Operation button”, if the licensing method L of ‘individuated’ 401 is satisfied, then the realization is the pronoun “it”. If individuated 401 is not licensed, then the cohesion filter 200 tests whether the licensing method L of ‘instance of a kind’ 405 is satisfied in the discourse history 220, and if so, then the realization method M of instance of a kind is used, and the result is “the button.”

Cohesion Filter Method

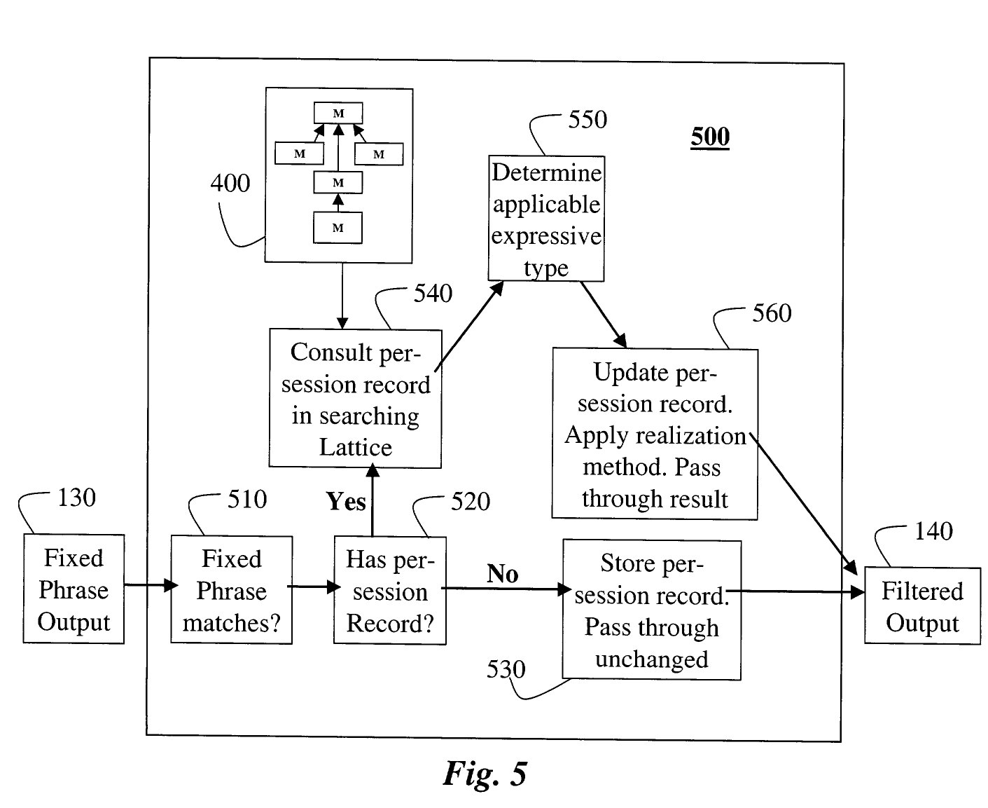

FIG. 5 show the peroration of the cohesion filter method 500. The cohesion filter 500 is like a transducer that sequential receives the phrases of the output 130 produced by the generator 120 of the application 110. The filter modifies the wording of the fixed phrases that have been registered with the filter, and modifies filtered output to the target component 150.

The output 130 is examined 510 for segments that match any of the fixed phrases that have been registered with the cohesion filter 500. When there is a match, the cohesion filter determines 520 whether the matched fixed phrase has a per-session record 350 in the discourse history 220 for this session. If the answer is no, then this is the initial reference to the fixed phrase. A new per-session record 350 is stored 530 for the fixed phrase 310. In this case, the expressive type 320 in the fixed phrase's permanent record 300 applies, and as a result the fixed phrase is passed through unchanged.

If the fixed phrase does have a per-session record 520, thereby indicating that this is a subsequent reference to this fixed phrase, then the lattice of expressive types 400 is searched 540 to determine the realization of the fixed phrase for this instance. A line in the lattice 400, from the expressive type 330 recorded in the fixed phrase's permanent record, up to the top, root node of the lattice, is identified, and the licensing methods L of each expressive type is tested 550 against the per-session record and the state of the discourse history 220, starting with the top node and moving down until the licensing method L of some expressive type S is satisfied.

The next step 560 applies the realization method M associated with the selected expressive type S to generate new filtered output, store a new instance record 370, add the record to the stack 360 of the per-session record 350 of the matched fixed phrase 310, and to pass the filtered output to the target component.

The effect of the cohesion filter is illustrated by the following example, an except of a dialog between a steam plant tutoring application and a student. ‘Phrase 1’ and ‘phrase 2’ are successive segments of the original text 130 that are passed sequentially to the cohesion filter as part of the same session. Instances of the fixed phrase of interest, “the Operation button” appear in this example as ‘[OB]’.

Phrase 1: Press [OB].

<user presses the button>

Phrase 2: Right. Now notice that [OB] is red, indicating that we are viewing the

operation panel. Ok?

The instance of the fixed phrase OB in Phrase 1 is the initial reference of OB. Consequently, this phrase is passed though to the target component as is, after a per-session record is stored. In Phrase 2, the fixed phrase OB is again matched 510 but this time the check for a per-session record 520 succeeds. The corresponding per-session record 350 is consulted to determine that in the previous instance of OB the leaf expressive type 402 assigned to OB in its permanent record 300 was used. The line of expressive types up from that leaf type up to the root is identified as 402, 405, and 401, and the licensing methods L of those identified expressive types are then applied to OB's per-instance record and the context supplied by the discourse history of this session 220 as a whole.

Whether the licensing method L of the topmost expressive type ‘individuated’ is satisfied, resulting in the subsequent reference “it,”, or whether individuated licensing method fails and the licensing method L of the next expressive type down in the lattice, ‘instance of a kind’ is satisfied, resulting in the subsequent reference “the button,” depends on the criteria used in those licensing methods. In either case, the realization method M of the satisfied expressive type is applied 560 to the fixed phrase OB, a new instance record 370 is stored, and added to the stack 360 of the per-session record for OB 350, and the resulting alternative, filtered output is passed on to the target component.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. A method for filtering natural language output including fixed phrases, comprising:
determining sequentially, for each fixed phrase, whether the fixed phrase has occurred in a discourse history;
passing the fixed phrase to a target component if the fixed phrase does not occur in the discourse history; and otherwise
searching a subsumption lattice for a expressive type associated with the fixed phrase that is licensed in a context of the discourse history;
converting the fixed phrase to a filtered phrase according a realization method of the licensed expressive type; and
passing the filtered phrase to the target component.
